(19) United States
(12) Patent Application Publication
(10) Pub. No.: US 2024/0349180 A1
(43) Pub. Date: Oct. 17, 2024

(54) METHOD AND SYSTEM FOR COMMUNICATING IN A COMMUNICATION NETWORK COMPRISING NODES PROVIDED WITH RADIO AND PLC COMMUNICATION MEANS AND NODES PROVIDED WITH SOLELY RADIO COMMUNICATION MEANS

(71) Applicant: SAGEMCOM ENERGY & TELECOM SAS, Bois-Colombes (FR)

(72) Inventor: Kaveh RAZAZIAN, Bois-Colombes (FR)

(73) Assignee: SAGEMCOM ENERGY & TELECOM SAS, Bois-Colombes (FR)

(21) Appl. No.: 18/615,865

(22) Filed: Mar. 25, 2024

(30) Foreign Application Priority Data
Apr. 14, 2023 (FR) 2303758

(51) Int. Cl. H04W 52/02; H04B 3/54

(52) U.S. Cl. CPC H04W 52/02; H04B 3/54

(57) ABSTRACT

A method and a system for communicating in a communication network including nodes provided with radio and PLC communication means, fulfilling a role of relay for increasing the range of the communications in the communication network, communicating by means of a predetermined communication protocol, processing broadcast messages and processing authentication requests from other nodes. According to the invention, the system further includes nodes provided with solely radio communication means able to communicate partly in accordance with the same protocol used by the nodes provided with radio and PLC communication means, and each node provided with solely radio communication means receives broadcast messages, does not process the broadcast messages, receives join-request messages, and does not process the joint-request messages.

### TECHNICAL FIELD

The present invention relates to a method and a system for communicating in a communication network comprising nodes provided with radio and PLC communication means and nodes provided with solely radio communication means

### PRIOR ART

Powerline communications (PLCs) are developing, in particular in the context of electrical supply networks of the AMM type (the acronym meaning “automated meter management”). Communication networks are thus implemented in electrical supply networks for the automated collection, by a base node (also referred to as “data concentrator”) of the network, from nodes such as smart electricity meters, energy consumption reading data that the smart electricity meters are respectively responsible for monitoring.

By way of example, in an evolution of the G3-PLC standard, an RF (the acronym for radiofrequency) radio channel can be used in place of one of said PLC frequency bands as defined in the standard entitled Narrowband OFDM PLC specifications for G3 PLC networks of March 2022.

Other smart meters, such as meters for the consumption of fluid such as gas or water, are supplied only by a battery and communicate by radio using for example the Zigbee protocol or the Wireless M-Bus (Wireless Meter Bus) protocol, which is an adaptation of the M-Bus cable standard to radio. Wireless M-Bus represents the European communication standard for remote readings.

For a fluid-consumption meter to be able to communicate with a smart electricity meter, it is necessary to equip the meter with a radio module in accordance with the same protocol used by the electricity meter (for example: the G3-PLC/RF hybrid protocol, the PRIME/RF hybrid protocol, the Wi-SUN protocol, etc). Nevertheless, if it is wished to guarantee correct operation of the fluid meters over time, it is necessary to optimise the electrical energy consumption thereof, which makes it impossible to use the specification for PLC and RF hybrid networks (for example hybrid G3-PLC and hybrid PRIME) or for RF networks (for example Wi-SUN).

### DISCLOSURE OF THE INVENTION

For this purpose, according to a first aspect, one embodiment proposes a method for communicating in a communication network comprising nodes provided with radio and PLC communication means, the data concentrator and the nodes provided with radio and PLC communication means forming a mesh communication network, the nodes comprising nodes provided with radio and PLC communication means fulfilling a role of relay for increasing the range of the communications in the mesh communication network, the nodes provided with radio and PLC communication means communicating by means of a predetermined communication protocol, processing broadcast messages and processing authentication requests from other nodes, characterised in that the system further comprises nodes provided with solely radio communication means able to communicate partly in accordance with the same protocol used by the nodes provided with radio and PLC communication means, and in that the method comprises the steps, performed by each node provided with solely radio communication means, of:
receiving broadcast messages,
not processing the broadcast messages,
receiving join-request messages,
not processing the join-request messages.

One embodiment also relates to a system for communicating in a communication network comprising nodes provided with radio and PLC communication means, the data concentrator and the nodes provided with radio and PLC communication means forming a mesh communication network, the nodes comprising nodes provided with radio and PLC communication means fulfilling a role of relay for increasing the range of the communications in the mesh communication network, the nodes provided with radio and PLC communication means communicating by means of a predetermined communication protocol, processing broadcast messages and processing authentication requests from other nodes, characterised in that the system further comprises nodes provided with solely radio communication means able to communicate partly in accordance with the same protocol used by the nodes provided with radio and PLC communication means, and in that the nodes provided with solely radio communication means comprise:
means for receiving broadcast messages,
means for not processing the broadcast messages,
means for receiving join-request messages,
means for not processing the join-request messages.

Thus the nodes provided with solely radio communication means are able to communicate with the nodes provided with radio and PLC communication means without the latter using a communication protocol other than the one used by the nodes provided with radio and PLC communication means in the communication network.

By not implementing some functionalities of the communication protocol, the electrical energy consumption of the nodes provided with solely radio communication means becomes compatible for nodes operating on battery.

According to a particular embodiment, when a node provided with solely radio communication means is introduced into the communication network, the node provided with solely radio communication means:
selects a node provided with radio and PLC communication means,
transfers a message to the node selected for authentication of the node provided with solely radio communication means in the communication network,
goes into an operating mode wherein the radio communication means are deactivated for a predetermined period if the authentication has not succeeded,
transfers a message to the node selected for creating a route with the selected node if the authentication has succeeded,
goes into an operating mode wherein the radio communication means are deactivated for a predetermined period if the route creation has not succeeded.

Thus the electrical energy consumption of the nodes provided with solely radio communication means is reduced.

According to a particular embodiment, if the creation of the route has succeeded, the node provided with solely radio communication means:
transfers a message to the node selected for joining of the node provided with solely radio communication means with the selected node,
transfers a message to the node with which it is joined if the joining has succeeded,
goes into the operating mode wherein the radio communication means are deactivated for a predetermined period if the message has been received by the node with which it is joined.

According to a particular embodiment, if the creation of the route has succeeded, the node provided with solely radio communication means:
goes into the operating mode wherein the radio communication means are deactivated for a predetermined period if the joining has not succeeded.

According to a particular embodiment, at the end of the predetermined period, the node goes into a mode wherein the radio communication means are reactivated, and the node:
seeks a node provided with radio and PLC communication means different from the node with which the joining has not succeeded.

According to a particular embodiment, the data concentrator is configured to collect, from the nodes provided with radio and PLC communication means, reading data on the energy consumption of electrical installations that said nodes are respectively responsible for monitoring, and the nodes provided with solely radio communication means are smart fluid meters.

A particular embodiment also relates to a computer program product. It comprises instructions for implementing, by an item of equipment, the method according to one of the preceding embodiments, when said program is executed by a processor of the equipment.

A particular embodiment also relates to a storage medium. It stores a computer program comprising instructions for implementing, by a node device, the method according to one of the preceding embodiments, when said program is executed by a processor of the node device.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 illustrates schematically an example of a communication network according to the present invention;

FIG. 2 illustrates schematically the architecture of a node provided with solely radio communication means according to one embodiment;

FIG. 3 illustrates schematically the architecture of a node provided with radio and PLC communication means according to one embodiment;

FIG. 4 illustrates an example of an authentication and route-creation method implemented by a leaf node according to one embodiment;

FIG. 5 illustrates an example of a joining method implemented by a node provided with solely radio communication means according to one embodiment;

FIG. 6 illustrates an example of a joining method implemented by a node provided with radio and PLC communication means according to one embodiment;

FIG. 7 illustrates an example of a message-processing method implemented by a node provided with solely radio communication means according to one embodiment.

### DETAILED DISCLOSURE OF EMBODIMENTS

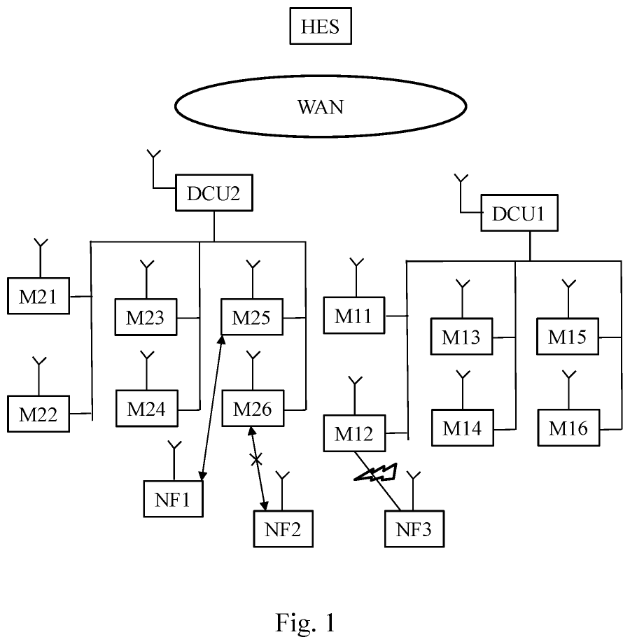

FIG. 1 illustrates an example of a communication network in one embodiment.

In the example in FIG. 1, the communication network comprises a head end system HES that is connected by means of a communication network to a plurality of data concentrators, here two in FIG. 1, DCU1 and DCU2. The data concentrator DCU1 is connected to a plurality of nodes provided with radio and PLC communication means denoted M11 to M16 and the data concentrator DCU2 is connected to a plurality of nodes provided with radio and PLC communication means denoted M21 to M26. The role of the head end system or systems HES is to automatically acquire the data from the meters, avoiding any human intervention, and to monitor the parameters acquired from the nodes. The head end system HES manages the connectivity and plans the collection of data from the metering infrastructure, including the nodes and the communication.

The nodes provided with radio and plc communication means M11 to M16 and M21 to M26 are for example smart electricity meters and can communicate with the various nodes provided with radio and PLC communication means and with the data concentrators DCU1 and DCU2 through their PLC or RF communication interfaces.

The nodes provided with radio and PLC communication means implement the specification for the PLC and RF hybrid networks (for example: hybrid G3-PLC or hybrid PRIME) or the RF network only (for example Wi-SUN, standing for Wireless Smart Utility Network).

According to the invention, nodes NF1, NF2 and NF3, hereinafter referred to as leaf nodes, are inserted in the communication network. The leaf nodes are able to communicate solely through their radio interface with the nodes provided with radio and PLC communication means M11 to M16 and M21 to M26 and partly implement the specification for the PLC and RF hybrid networks such as for example hybrid G3-PLC or hybrid PRIME or solely the RF networks such as for example Wi-SUN.

The leaf nodes NF1, NF2 and NF3 are for example smart fluid meters.

The leaf nodes NF1, NF2 and NF3 are able to authenticate themselves automatically with the network and to acquire the network identifiers (the reduced MAC address, the network identifier and the security key) necessary for establishing a secure bidirectional communication with an authentication agent.

The leaf nodes NF1, NF2 and NF3 are able to establish a route using unicast messages to a node with which they are authenticated.

The leaf nodes NF1, NF2 and NF3 are able to select and attach themselves to a node provided with radio and PLC communication means referred to as parent node, which is responsible for storing the messages received from each leaf node to be sent on demand to the data concentrator and the head end system.

Being authenticated in the network, a leaf node according to the invention, and unlike the nodes provided with radio and PLC communication means, ignores all the packets broadcast at the MAC sublayer level (short MAC destination address=0xFFFF), ignores all the authentication requests (beacon requests) to the network broadcast by the non-authenticated nodes and communicates solely in unicast with its selected parent.

In the example in FIG. 1, the leaf node NF1 is attached to and associated with the node provided with radio and PLC communication means M25, the leaf node NF2 is attached to the node provided with radio and PLC communication means M26 but is not joined therewith, and the leaf node NF3 is attached to and joined with the node provided with radio and PLC communication means M12 but loses the communication link with the node provided with radio and PLC communication means M12.

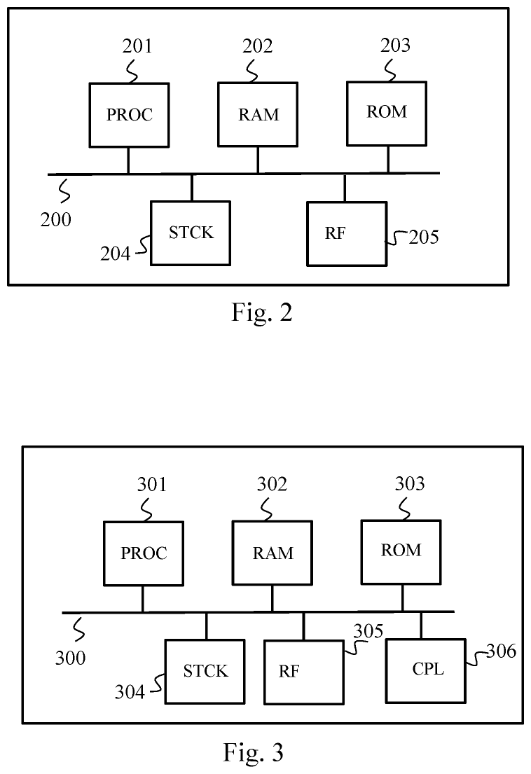

FIG. 2 illustrates schematically the architecture of a node provided with solely radio communication means according to one embodiment.

According to the example of hardware architecture shown in FIG. 2, the nodes NF1, NF2 and NF3 comprise, connected by a communication bus 200: a processor or CPU (“central processing unit”) 201; a random access memory (RAM) 202; a read only memory (ROM) 203; a storage unit such as a hard disk (or a storage medium reader, such as an SD (Secure Digital) card reader 204; an RF communication interface 205 enabling the node to communicate with at least one parent node.

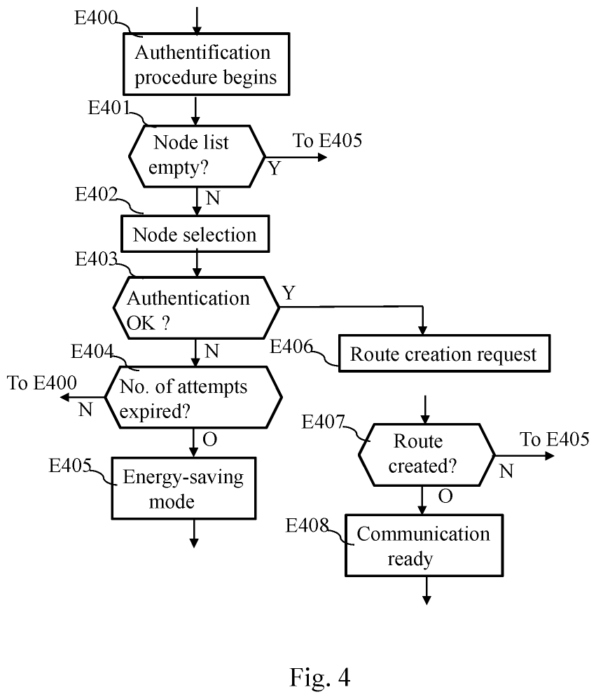

The processor 201 is capable of executing instructions loaded in the RAM 202 from the ROM 203, from an external memory (not shown), from a storage medium (such as an SD card), or from a communication network. When the node is powered up, the processor 201 is capable of reading instructions from the RAM 202 and executing them. These instructions form a computer program causing the implementation, by the processor 201, of all or part of the method described in relation to FIGS. 4, 5 and 7.

The method described below in relation to FIGS. 4, 5 and 7 can be implemented in software form by executing a set of instructions by a programmable machine, for example a DSP (“digital signal processor”), or a microcontroller, or be implemented in hardware form by a machine or a dedicated component, for example an FPGA (field-programmable gate array) or an ASIC (application-specific integrated circuit). In general, the leaf node comprises electronic circuitry configured for implementing the methods described in relation to FIGS. 4, 5 and 7.

It should be noted here that a node provided with solely radio communication means can comprise the whole of the software for implementing the protocol of the specification for the PLC and RF hybrid networks such as for example hybrid G3-PLC or hybrid PRIME or solely the RF networks such as for example Wi-SUN. Predetermined information indicates to the node provided with solely radio communication means that only part of the protocol must be implemented.

FIG. 3 illustrates schematically the architecture of a node provided with radio and PLC communication means according to one embodiment.

According to the example of hardware architecture shown in FIG. 3, the nodes M11 to M16, M21 to M26 comprise, connected by a communication bus 300: a processor or CPU (“central processing unit”) 301; a random access memory (RAM) 302; a read only memory (ROM) 303; a storage unit such as a hard disk (or a storage medium reader, such as an SD (Secure Digital) card reader 304; an RF radio communication interface 305 enabling the node to communicate with at least one leaf node, the nodes provided with radio and PLC communication means and the data concentrator to which they are connected and a PLC communication interface 305 enabling the node to communicate with the nodes provided with radio and PLC communication means and the data concentrator to which they are connected.

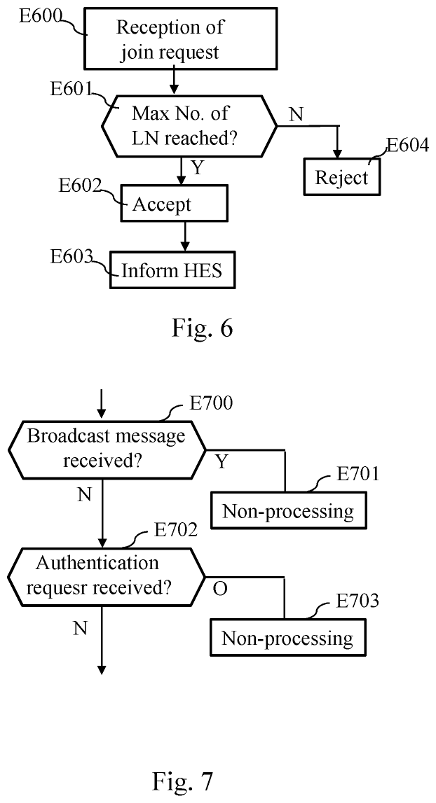

The processor 301 is capable of executing instructions loaded in the RAM 202 from the ROM 303, from an external memory (not shown), from a storage medium (such as an SD card), or from a communication network. When the node is powered up, the processor 301 is capable of reading instructions from the RAM 302 and executing them. These instructions form a computer program causing the implementation, by the processor 301, of all or part of the method described in relation to FIG. 6.

The method described below in relation to FIG. 6 can be implemented in software form by executing a set of instructions by a programmable machine, for example a DSP (“digital signal processor”), or a microcontroller, or be implemented in hardware form by a machine or a dedicated component, for example an FPGA (field-programmable gate array) or an ASIC (application-specific integrated circuit). In general, the node comprises electronic circuitry configured for implementing the method described in relation to FIG. 6.

FIG. 4 illustrates an example of an authentication and route-creation method implemented by a leaf node according to one embodiment.

At the step E400, an authentication procedure begins.

At the following step E401, the leaf node checks whether a list of nodes able to be a parent is empty. The list of nodes is obtained by performing a neighbourhood discovery operation and collecting all the responses sent by the neighbouring nodes provided with radio and PLC communication means

If so, the leaf node passes to the step E405. If not, the leaf node passes to the step E402.

At the step E402, the leaf node selects a node provided with radio and PLC communication means, For example, the leaf node selects the node provided with radio and PLC communication means for which the received signal has the best link-quality indicator and sends an authentication request message to the selected node.

When the selected node receives the message, it transfers the request to the data concentrator, which transfers it to the head end system HES, which authenticates the node or not. The response comprising an identification key is transferred to the leaf node by means of the data concentrator and the selected node.

At the step E403, the leaf node checks whether the authentication has been accepted.

If so, the leaf node passes to the step E406. If not, the leaf node passes to the step E404.

At the step E404, the leaf node checks whether a maximum number of authentication attempts has been reached.

If so, the leaf node passes to the step E405 and for a predetermined period goes into a so-called standby mode in which only the measurement of the fluid consumption is made and in which the radio communication means are deactivated.

If not, the leaf node returns to the step E400.

At the step E406, the leaf node passes to the authenticated state and becomes eligible to establish a route to the selected node and transfers to the selected node a request to create a route between the leaf node and the selected node. The leaf node stores the identifier of the selected node.

If the selected node accepts the creation of the route, the selected node updates a routing table and informs the head end system thereof via the data concentrator.

At the step E407, the leaf node checks whether the route creation request has been accepted. If so, the leaf node passes to the step E408; the communication link is thus created at the step E408.

If not, the leaf node passes to the step E405.

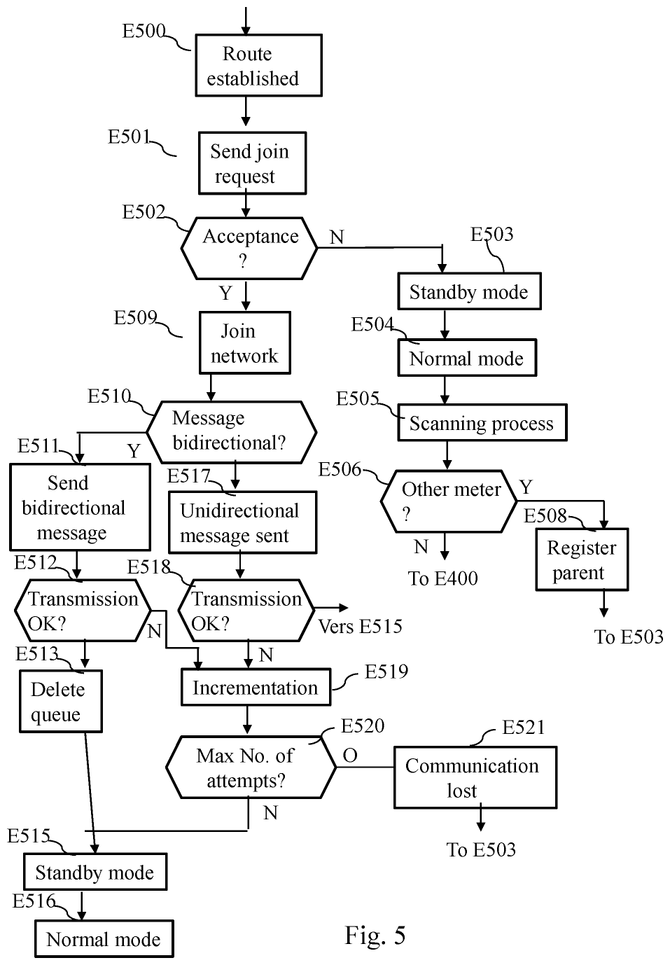

FIG. 5 illustrates an example of a joining method implemented by a node provided with solely radio communication means according to one embodiment.

At the step E500, the route has been established in accordance with the algorithm as described in relation to FIG. 4.

At the step E501, the leaf node demands the transfer of a join-request message to the node with which the route was created.

At the step E502, the leaf node checks whether the join request has been accepted.

If so, the leaf node passes to the step E509; if not, the leaf node passes to the step E503.

At the step E503, the leaf node goes into standby mode as described with reference to the step E405 of FIG. 4.

In the end of the predetermined period, the leaf node passes to the step E505 in a so-called normal mode in which the radio interface is activated.

At the step E505, the leaf node implements a neighbourhood scanning or discovery process by collecting all the responses sent by the neighbouring nodes provided with radio and PLC communication means.

At the step E506, the leaf node checks whether a node other than the node that refused the joining is detected following the scan.

If so, the leaf node passes to the step E508, and executes the algorithm as described with reference to FIG. 4 to authenticate itself by means of the node other than the node that refused the joining and to create a route with the node other than the node that refused the joining.

Once this operation has ended, the leaf node returns to the step E503.

If not, the leaf node passes from the step E506 to the step E400.

At the step E509, the leaf node is then joined with the network. The acceptance of the joining furthermore comprises information indicating whether the leaf node must send a message of the unidirectional or bidirectional type.

At the step E510, the leaf node checks whether a bidirectional message must be sent.

If so, the leaf node passes to the step E511. If not, the leaf node passes to the step E517.

At the step E511, the leaf node receives a message of the request type from the node with which it is joined and in response sends a new message to it.

The node with which the leaf node is joined sends an acknowledgement message in the case of correct reception of the message sent by the leaf node.

At the step E512, the leaf node checks whether the acknowledgement is well received.

If so, the leaf node passes to the step E513. If not, the leaf node passes to the step E519.

At the step E513, the leaf node deletes from a queue the message of the request received type and passes to the step E515 to go into a standby mode for a predetermined period.

In the end of the predetermined period, the leaf node passes to the step E516 in a so-called normal mode in which the radio interface is activated.

At the step E517, the leaf node sends a message to the node with which it is joined and in response the node with which the leaf node is joined sends an acknowledgement message in the case of correct reception of the message sent by the leaf node.

At the step E518, the leaf node checks whether the acknowledgement message is well received.

If so, the leaf node passes to the step E515. If not, the leaf node passes to the step E519.

At the step E519, the leaf node increments a variable representing the number of retransmissions made for the message.

At the step E520, the leaf node checks whether the variable implemented at the step E519 is equal to a maximum number of attempts at sending the message.

If so, the leaf node passes to the step E521. If not, the leaf node passes to the step E515.

At the step E521, the leaf node determines that the communication with the node with which it is joined is interrupted and returns to the step E503.

FIG. 6 illustrates an example of a joining method implemented by a node provided with radio and PLC communication means according to one embodiment.

At the step E600, the node provided with radio and PLC communication means receives from a leaf node with which a route has been created a join request message as described at the step E501 of FIG. 5.

At the step E601, the node provided with radio and PLC communication means checks whether the number of leaf nodes that are joined with it is equal to a maximum number of leaf nodes that are joined with it.

If so, the node provided with radio and PLC communication means sends at the step E604 a message rejecting the joining. If not, the node provided with radio and PLC communication means demands at step E602 the transfer of a message accepting the joining and informs the head and system HES of the joining at the step E603.

FIG. 7 illustrates an example of a message-processing method implemented by a node provided with solely radio communication means according to one embodiment.

At the step E700, the leaf node provided with solely radio communication means or leaf node checks whether a broadcast message is received. If so, the leaf node passes to the step E701 and does not process the message received.

If not, the leaf node passes to the step E702.

At the step E702, the leaf node checks whether a message comprising an authentication request is received. If so, the leaf node passes to the step E703 and does not process the message received.

If not, the leaf node returns to the step E700.

1. A method for communicating in a communication network comprising nodes provided with radio and PLC communication means, a data concentrator, and the nodes provided with radio and PLC communication means forming a mesh communication network, the nodes comprising nodes provided with radio and PLC communication means fulfilling a role of relay for increasing the range of the communications in the mesh communication network, the nodes provided with radio and PLC communication means communicating by means of a predetermined communication protocol, processing broadcast messages and processing authentication requests from other nodes, wherein the system further comprises nodes provided with solely radio communication means able to communicate partly in accordance with the same protocol used by the nodes provided with radio and PLC communication means, and said method causing each node provided with solely radio communication means, of:
receiving broadcast messages,
not processing the broadcast messages,
receiving join-request messages,
not processing the join-request messages.

2. The method according to claim 1, wherein when a node provided with solely radio communication means is introduced into the communication network, the node provided with solely radio communication means:
selects a node provided with radio and PLC communication means,
transfers a message to the node selected for authentication of the node provided with solely radio communication means in the communication network,
goes into an operating mode wherein the radio communication means are deactivated for a predetermined period if the authentication has not succeeded,
transfers a message to the node selected for creating a route with the selected node if the authentication has succeeded,
goes into an operating mode wherein the radio communication means are deactivated for a predetermined period if the route creation has not succeeded.

3. The method according to claim 2, wherein if the creation of the route has succeeded, the node provided with solely radio communication means:
transfers a message to the node selected for joining of the node provided with solely radio communication means with the selected node,
transfers a message to the node with which it is joined if the joining has succeeded,
goes into the operating mode wherein the radio communication means are deactivated for a predetermined period if the message has been received by the node with which it is joined.

4. The method according to claim 3, wherein if the creation of the route has succeeded, the node provided with solely radio communication means:
goes into the operating mode wherein the radio communication means are deactivated for a predetermined period if the joining has not succeeded.

5. The method according to claim 4, wherein at the end of the predetermined period, the node goes into a mode wherein the radio communication means are reactivated, and the node:
seeks a node provided with radio and PLC communication means different from the node with which the joining has not succeeded.

6. A system for communicating in a communication network comprising nodes provided with radio and PLC communication means, a data concentrator, and the nodes provided with radio and PLC communication means forming a mesh communication network, the nodes comprising nodes provided with radio and PLC communication means fulfilling a role of relay for increasing the range of the communications in the mesh communication network, the nodes provided with radio and PLC communication means communicating by means of a predetermined communication protocol, processing broadcast messages and processing authentication requests from other nodes, wherein the system further comprises nodes provided with solely radio communication means able to communicate partly in accordance with the same protocol used by the nodes provided with radio and PLC communication means, and in that the nodes provided with solely radio communication means comprise circuitry causing the node to implement:
receiving broadcast messages,
not processing the broadcast messages,
receiving join-request messages,
not processing the join-request messages.

7. The system according to claim 6, wherein the data concentrator is configured to collect, from the nodes provided with radio and PLC communication means, reading data on the energy consumption of electrical installations that said nodes are respectively responsible for monitoring, and the nodes provided with solely radio communication means are smart fluid meters

8. A computer program product comprising instructions for implementing, by an item of equipment, the method according to claim 1, when said program is executed by a processor of a node.

9. A storage medium storing a computer program comprising instructions for implementing, by an item of equipment, the method according to claim 1, when said program is executed by a processor of a node.
